(19) United States
(12) Patent Application Publication
(10) Pub. No.: US 2019/0285404 A1
(43) Pub. Date: Sep. 19, 2019

(54) NONCONTACT THREE-DIMENSIONAL MEASUREMENT SYSTEM

(71) Applicant: FARO Technologies, Inc., Lake Mary, FL (US)

(72) Inventor: Denis Wohlfeld, Ludwigsburg (DE)

(21) Appl. No.: 16/259,432

(22) Filed: Jan. 28, 2019

Related U.S. Application Data
(60) Provisional application No. 62/644,127, filed on Mar. 16, 2018.

(51) Int. Cl. G01B 11/25; G01B 11/00; G06T 7/521; G06T 7/73; H04N 5/247; G06T 7/33

(52) U.S. Cl. CPC G01B 11/2513; G01B 11/002; G06T 7/521; G06T 2207/10028; H04N 5/247; G06T 7/33; G06T 2207/10024; G06T 7/73

(57) ABSTRACT

A system and method for noncontact measurement of an environment is provided. The system includes a measurement system having a light projector. The measurement system is coupled to a tablet computer having a camera. The tablet computer causes the measurement system to project a light pattern onto the surface. An image of the light pattern on the surface is acquired. Three dimensional coordinates of points on the surface and a plane are determined from the image. A color image is acquired and two lines are determined. The two lines are matched to the plane. The color image and the three-dimensional coordinates are aligned based on the matching of the two lines to the plane.

### CROSS REFERENCE TO RELATED APPLICATIONS

This application claims the benefit of U.S. Provisional Application Ser. No. 62/644,127 filed Mar. 16, 2018, the contents of which is incorporated herein by reference in its entirety.

### BACKGROUND

The present invention relates generally to a system and method of measuring an environment, and in particular, to a system and method that rapidly measures planes in an environment and generates a sparse point cloud.

Noncontact measurement systems, such as a 3D imager for example, use a triangulation method to measure the 3D coordinates of points on an object. The 3D imager usually includes a projector that projects onto a surface of the object either a pattern of light in a line or a pattern of light covering an area. A camera is coupled to the projector in a fixed relationship, for example, by attaching a camera and the projector to a common frame. The light emitted from the projector is reflected off the object surface and detected by the camera. Since the camera and projector are arranged in a fixed relationship, the distance to the object may be determined using trigonometric principles. Compared to coordinate measurement devices that use tactile probes, triangulation systems provide advantages in quickly acquiring coordinate data over a large area. As used herein, the resulting collection of 3D coordinate values or data points of the object being measured by the triangulation system is referred to as point cloud data or simply a point cloud.

With traditional 3D imagers, the number of data points on the object would be large, such as X points per square meter for example. This allowed the 3D imager to acquire very accurate representations of the object or environment being scanned. As a result, these traditional 3D imagers tended to be very expensive and in some cases required specialized training to use. Further, due to the number of points acquired, the process could be slow and computationally intensive.

It should be appreciated that traditional 3D imagers may not be suitable or desirable for some applications due to cost and speed considerations. These applications include measurements made by architects, building contractors or carpenters for example. In these applications, an existing space within a building may be in the process of being renovated. Typically, these measurements are made manually (e.g. a tape measure) and written on paper with a sketch of the area. As a result, measurements may contain errors, be missing, or otherwise incomplete, requiring multiple visits to the job site.

Accordingly, while existing triangulation-based 3D imager devices are suitable for their intended purpose, the need for improvement remains, particularly in providing a low cost noncontact measurement device that may quickly measure an environment.

### BRIEF DESCRIPTION

According to an embodiment of the present invention, a system for noncontact measurement of an environment is provided. The system includes a measurement system having a baseplate and a light projector, the light projector being mounted to the baseplate. A tablet computer is coupled to the measurement system and having a processor, memory, a user interface and a tablet camera, the camera having a second resolution, the second resolution being higher than the first resolution, the processor being operably coupled to the light projector, the processor being responsive to nontransitory executable computer instructions, when executed on the processor for performing a method comprising: causing the light projector to emit a light pattern onto a plurality of surfaces in the environment and causing the tablet camera to acquire an image of the light pattern at a first instance on the plurality of surfaces; causing the tablet camera to acquire a color image of the plurality of surfaces; determining three-dimensional coordinates of points on the plurality of surfaces based at least in part on the image of the light pattern acquired at the first instance, and determining at least one plane in the environment from the three-dimensional coordinates; determining a plurality of contrast lines in the color image; matching at least two lines of the plurality of lines to the at least one plane; and aligning the color image and the three-dimensional coordinate of points into a common coordinate frame of reference.

According to an embodiment of the present invention, a method for noncontact measurement of an environment, the method comprising: projecting a light pattern with a light projector onto a plurality of surfaces in the environment; acquiring at a first instance, with at least one camera, an image of the light pattern on the plurality of surfaces, the light projector and the at least one camera being coupled to a baseplate in a predetermined geometrical relationship; acquiring a color image of the plurality of surfaces with a camera of a table computer; determining three-dimensional coordinates of points on the plurality of surfaces based at least in part on the image of the light pattern acquired at the first instance and the predetermined geometrical relationship; determining at least one plane in the environment from the three-dimensional coordinates; determining a plurality of lines in the color image; matching at least two lines of the plurality of lines to the at least one plane; and aligning the color image and the three-dimensional coordinate of points into a common coordinate frame of reference.

According to an embodiment of the present invention, a system for noncontact measurement of an environment is provided. The system includes a case having a first side and a second side. A measurement system is coupled to the first side, the measurement system having a baseplate, a light projector and at least one camera, the light projector and a first camera being mounted to the baseplate in a predetermined geometric relationship, the at least one camera having a first resolution. A tablet computer is coupled to the second side, the tablet computer having a processor, memory, a user interface and a second camera, the user interface being visible to an operator from the second side, the camera having a second resolution, the second resolution being higher than the first resolution, the processor being operably coupled to the light projector and the at least one camera, the processor being responsive to nontransitory executable computer instructions, when executed on the processor for performing a method comprising: causing the light projector to emit a light pattern onto a plurality of surfaces in the environment; causing the first camera to acquire a first image of the light pattern on the plurality of surfaces; causing the second camera to acquire a second image of the light pattern; causing the second camera to acquire a color image of the plurality of surfaces; determining three-dimensional coordinates of points on the plurality of surfaces based at least in part on the first image and the second image of the light pattern and the predetermined geometrical relationship, and determining at least one plane in the environment from the three-dimensional coordinates; determining a plurality of lines in the color image; matching at least two lines of the plurality of lines to the at least one plane; and aligning the color image and the three-dimensional coordinates of points into a common coordinate frame of reference.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of a 3D measurement system according to an embodiment;

FIG. 2 is a front view of the system of FIG. 1 according to an embodiment;

FIG. 3 is a schematic view of the system of FIG. 1;

FIG. 4 is a schematic illustration of the principle of operation of a triangulation scanner having a camera and a projector according to an embodiment;

FIG. 5 is a schematic illustration of the principle of operation of a triangulation scanner having two cameras and one projector according to an embodiment;

FIG. 6 is a perspective view of the system of FIG. 1 having two cameras and one projector arranged in a triangle for 3D measurement according to an embodiment;

FIG. 7 and FIG. 8 are schematic illustrations of the principle of operation for measuring three-dimensional coordinates using the system of FIG. 6;

FIG. 9 is a schematic illustration of the operation of the system of FIG. 6;

FIG. 10 is a method of measuring an environment using the system of FIG. 1;

FIG. 11 is a perspective view of a 3D measurement system having two cameras and on projector arranged linearly according to another embodiment;

FIG. 12 is a schematic illustration of a triangulation scanner having a projector that projects an uncoded pattern of uncoded spot according to another embodiment;

FIG. 13 is an illustration of an uncoded pattern of uncoded spots according to an embodiment;

FIG. 14 an illustration of a method that may be used to determine a nearness of intersection of three lines according to an embodiment;

FIG. 15 is a flow diagram of a method for determining 3D coordinates of points on a surface of an object according to an embodiment;

FIG. 16 is a perspective view of a 3D measurement system having two-cameras and one projector according to another embodiment; and

FIG. 17 is a perspective view of a 3D measurement system having two-cameras and one projector according to another embodiment.

The detailed description explains embodiments of the invention, together with advantages and features, by way of example with reference to the drawings.

### DETAILED DESCRIPTION

Embodiments of the present invention provide advantages in rapid three-dimension measurements of the environment with a portable handheld device. Embodiments of the present invention provide further advantages of providing an imaging device that cooperates with a mobile computing device, such as a tablet computer, for rapidly acquiring three-dimensional measurements of an environment.

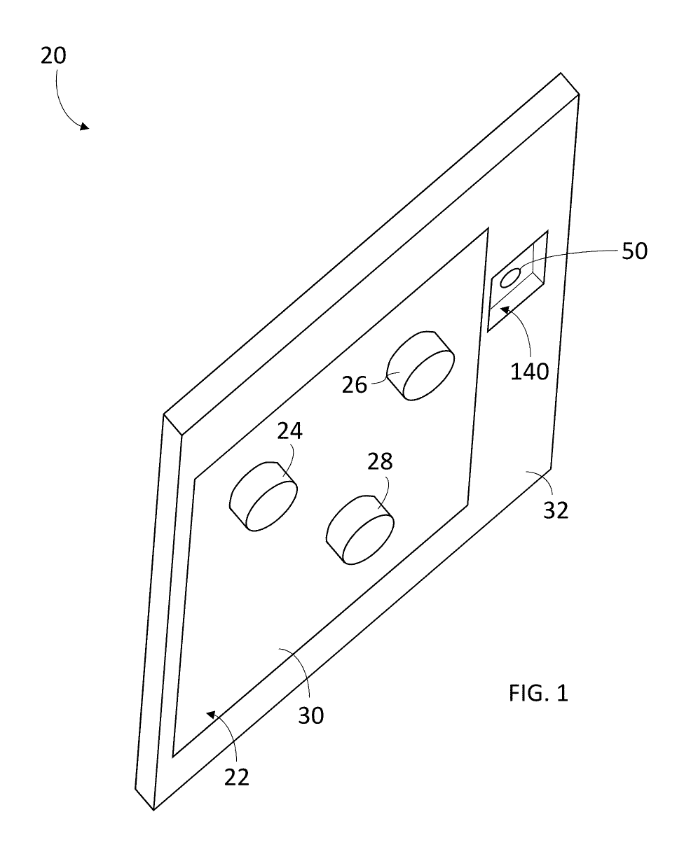

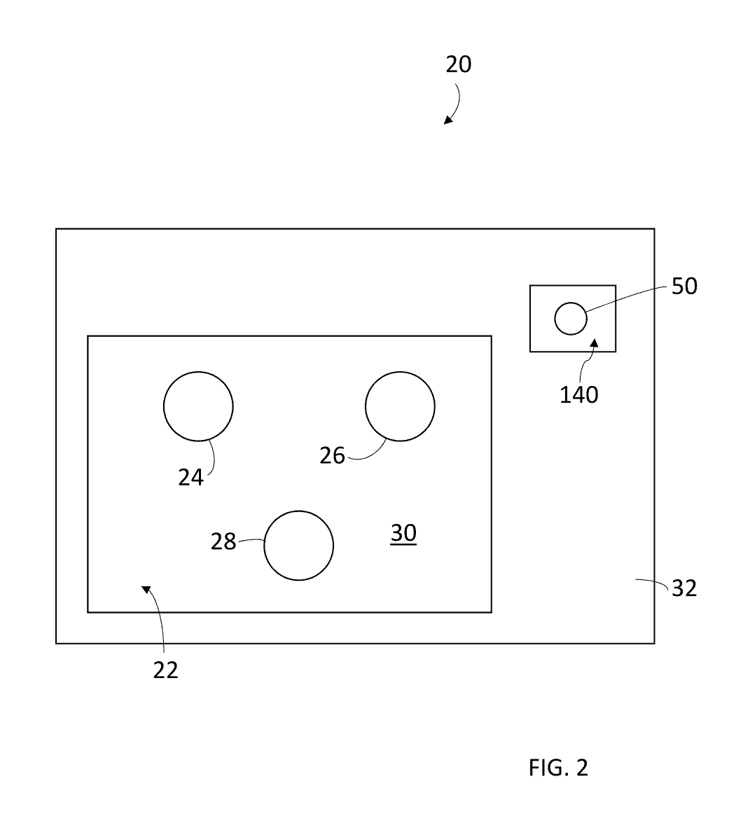

Referring now to FIGS. 1-3 an embodiment of a 3D imager 20 is shown that allows for the measurement an environment, such as the interior of a building for example. As described in more detail herein, the 3D imager 20 provides for the acquisition of one or more images at a single instance in time and the determination of 3D coordinates of planes based at least in part on those images. As a result, the 3D imager 20 can rapidly acquire dimensions of planes and surfaces in the environment.

The 3D imager 20 includes an optical system 22 having a first optical device 24, a second optical device 26 and a third optical device 28. In the exemplary embodiment, the optical devices 24, 26 are camera assemblies each having a lens and a photosensitive array. The third optical device 28 is a projector having a light source and a means for projecting a light pattern. The device 24, 26, 28 are mounted to a baseplate 30. The baseplate 30 is made from a material with a uniform and low coefficient of expansion so that the geometric arrangement of the devices 24, 26, 28 and the baseline distances therebetween are known. In an embodiment, the baseplate 30 is made from carbon fiber. In an embodiment, the devices 24, 26, 28 are mounted to an electronic circuit 29 that is mounted on the baseplate 30.

The baseplate 30 is coupled to a case 32. In the exemplary embodiment, the case 32 is made from a material, such as an elastomeric material for example, that protects the optical system and a mobile computing device 34 during operation and transport.

In the exemplary embodiment, the mobile computing device 34 is a tablet style computer that is removably coupled to the case 32. In an embodiment, the optical system 22 is disposed on a first side of the case 32 and the mobile computing device 34 is removably coupled to a second side of the case 32 opposite the first side.

The 3D imager 20 operation is controlled by the mobile computing device 34. Mobile computing device 34 is a suitable electronic device capable of accepting data and instructions, executing the instructions to process the data, and presenting the results. Mobile computing device 34 may accept instructions through user interface, or through other means such as but not limited to electronic data card, voice activation means, manually-operable selection and control means, radiated wavelength and electronic or electrical transfer. Therefore, mobile computing device 34 can be a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, a scientific computer, a scientific calculator, or a hybrid of any of the foregoing.

Mobile computing device 34 is capable of receiving signals from the optical system 22 (such as via electronic circuit 29) that represents an image of the surfaces in the environment. Mobile computing device 34 uses the images as input to various processes for determining three-dimensional (3D) coordinates of the environment.

Mobile computing device 34 is operably coupled with to communicate with the optical system 22 via a data transmission media. The data transmission media includes, but is not limited to, twisted pair wiring, coaxial cable, and fiber optic cable. The data transmission media also includes, but is not limited to, wireless, radio and infrared signal transmission systems. Mobile computing device 34 is configured to provide operating signals to components in the optical system 22 and to receive data from these components via the data transmission media.

In general, mobile computing device 34 accepts data from optical system 22, is given certain instructions for the purpose of determining 3D coordinates. Mobile computing device 34 provides operating signals to optical system 22, such as to project a light pattern and acquire an image. Additionally, the signal may initiate other control methods that adapt the operation of the 3D Imager 20 to compensate or calibrate for the out of variance operating parameters. For example, in an embodiment the calibration of the devices 24, 26, 28 is performed at each time instant where a light pattern is projected and an image is acquired.

The data received from optical system 22, the 3D coordinates or an image from a camera integrated into the mobile computing device 34 may be displayed on a user interface coupled to controller 38. The user interface may be an LCD (liquid-crystal diode) touch screen display, or the like. A keypad may also be coupled to the user interface for providing data input to mobile computing device 34.

In addition to being coupled to one or more components within 3D Imager 20, mobile computing device 34 may also be coupled to external computer networks such as a local area network (LAN) and the Internet. The LAN interconnects one or more remote computers, which are configured to communicate with Mobile computing device 34 using a well-known computer communications protocol such as TCP/IP (Transmission Control Protocol/Internet(\hat{ }) Protocol), RS-232, ModBus, and the like. Additional 3D Imagers 20 may also be connected to LAN with the mobile computing devices 34 in each of these 3D Imagers 20 being configured to send and receive data to and from remote computers and other 3D Imagers 20. In an embodiment, the LAN is connected to the Internet. This connection allows mobile computing device 34 to communicate with one or more remote computers connected to the Internet.

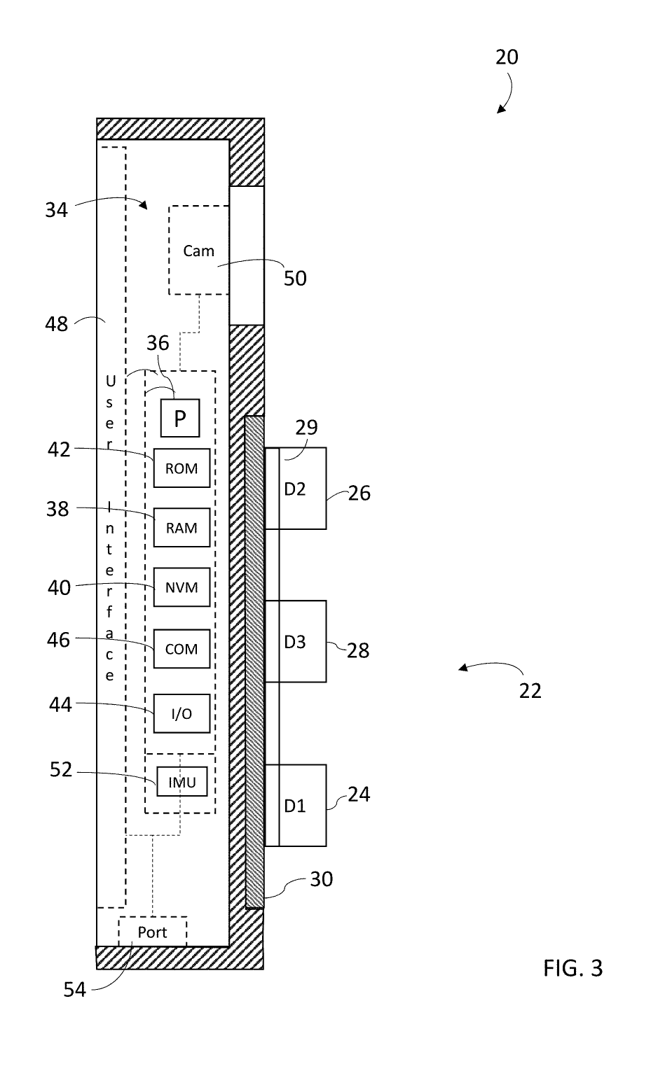

Referring now to FIG. 3, a schematic diagram of mobile computing device 34 is shown. Mobile computing device 34 includes a processor 36 coupled to a random access memory (RAM) device 38, a non-volatile memory (NVM) device 40, a read-only memory (ROM) device 42, one or more input/output (I/O) controllers 44, and a communications interface device 46 via a data communications bus.

I/O controllers 44 are coupled to components within the mobile computing device 34, such as the user interface 48, an inertial measurement unit 52 (IMU), and a digital camera 50 for providing digital data between these devices the processor 36. I/O controllers 44 may also be coupled to analog-to-digital (A/D) converters, which receive analog data signals. In an embodiment, the mobile computing device 34 may include a port 54 that allows the mobile computing device to transfer and receive signals from external devices.

The IMU 52 is a position/orientation sensor that may include accelerometers (inclinometers), gyroscopes, a magnetometers or compass, and altimeters. In the exemplary embodiment, the IMU 52 includes multiple accelerometers and gyroscopes. The compass indicates a heading based on changes in magnetic field direction relative to the earth's magnetic north. The IMU 52 may further have an altimeter that indicates altitude (height). An example of a widely used altimeter is a pressure sensor. By combining readings from a combination of position/orientation sensors with a fusion algorithm that may include a Kalman filter, relatively accurate position and orientation measurements can be obtained using relatively low-cost sensor devices. In the exemplary embodiment, the IMU 52 determines the pose or orientation of the 3D Imager 20 about three-axis to allow a determination of a yaw, roll and pitch parameter.

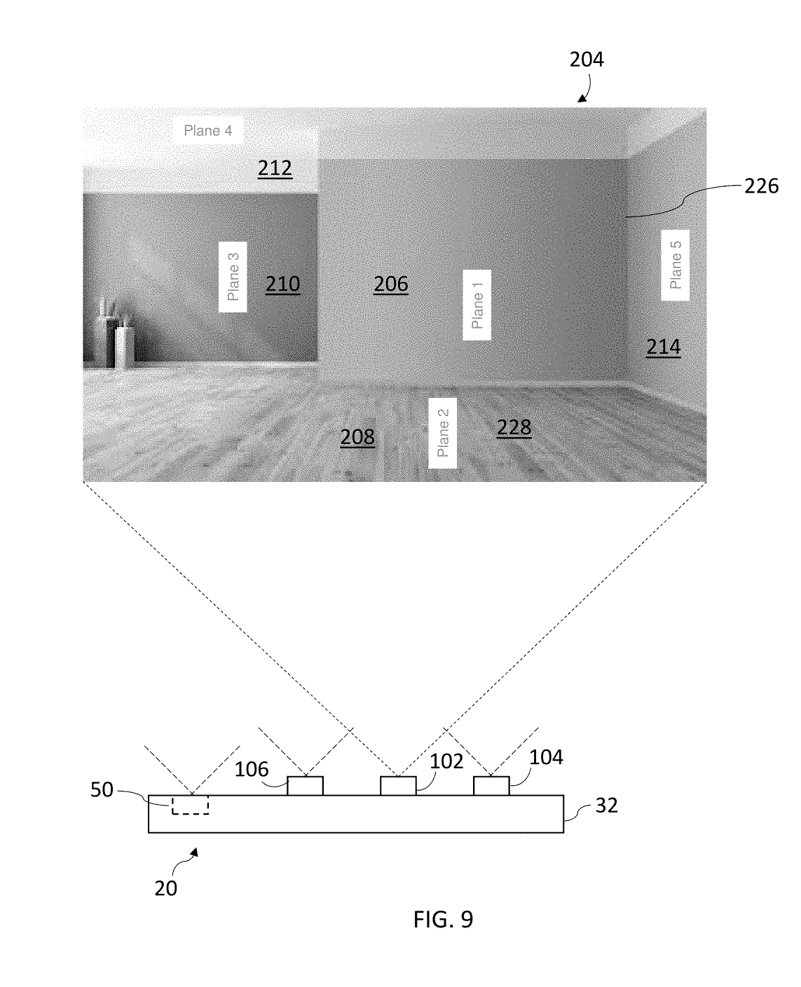

Communications interface device 46 provides for communication between mobile computing device 34 and external devices or networks (e.g. a LAN) in a data communications protocol supported by the device or network. ROM device 42 stores an application code, e.g., main functionality firmware, including initializing parameters, and boot code, for processor 36. Application code also includes program instructions as shown in FIG. 10 for causing processor 250 to execute any 3D Imager 20 operation control methods, including starting and stopping operation, acquiring images, determining 3D coordinates, displaying an image of the area measured, and generation of alarms or alerts. The application code creates an onboard telemetry system that cooperates with the IMU to determine operating information as the 3D Imager 20 is moved during operation.

NVM device 40 is any form of non-volatile memory such as an EPROM (Erasable Programmable Read Only Memory) chip, a disk drive, or the like. Stored in NVM device 40 are various operational parameters for the application code. The various operational parameters can be input to NVM device 40 either locally, using user interface 48 or remote computer, or remotely via the Internet using remote computer. It will be recognized that application code can be stored in NVM device 40 rather than ROM device 42.

Mobile computing device 34 includes operation control methods embodied in application code shown in FIG. 10 and the description of the determination of 3D coordinates described herein. These methods are embodied in computer instructions written to be executed by processor 36, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software.

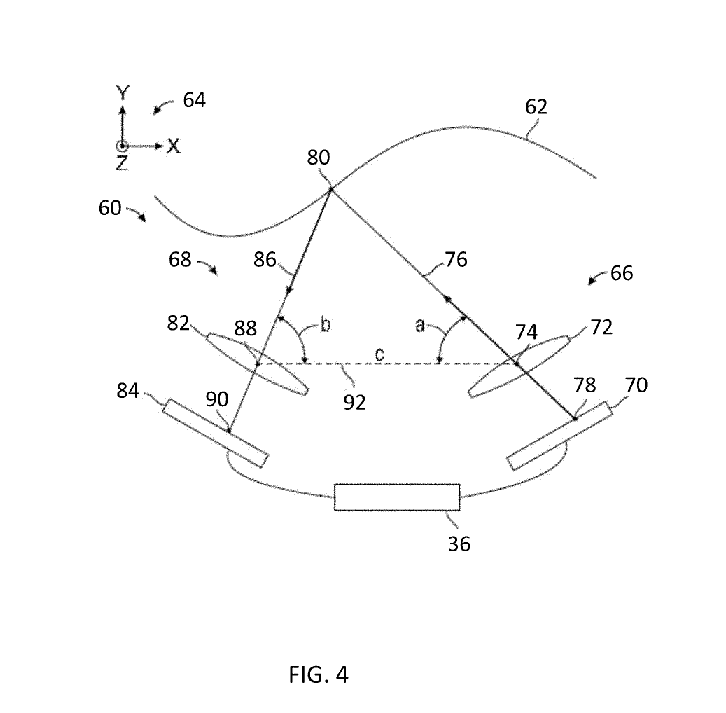

Referring now to FIG. 4 shows an embodiment of a structured light triangulation scanner 60 that projects a pattern of light over an area on a surface 62. The scanner, which has a frame of reference 64, includes a projector 66 and a camera 68. The projector 66 includes an illuminated projector pattern generator 70, a projector lens 72, and a perspective center 74 through which a ray of light 76 emerges. The ray of light 76 emerges from a corrected point 78 having a corrected position on the pattern generator 70. In an embodiment, the point 78 has been corrected to account for aberrations of the projector, including aberrations of the lens 72, in order to cause the ray to pass through the perspective center, thereby simplifying triangulation calculations.

The ray of light 76 intersects the surface 62 in a point 80, which is reflected (scattered) off the surface and sent through the camera lens 82 to create a clear image of the pattern on the surface 62 on the surface of a photosensitive array 84. The light from the point 80 passes in a ray 86 through the camera perspective center 88 to form an image spot at the corrected point 90. The image spot is corrected in position to correct for aberrations in the camera lens. A correspondence is obtained between the point 90 on the photosensitive array 84 and the point 78 on the illuminated projector pattern generator 70. As explained herein below, the correspondence may be obtained by using a coded or an uncoded (sequentially projected) pattern. Once the correspondence is known, the angles a and b in FIG. 4 may be determined. The baseline 92, which is a line segment drawn between the perspective centers 78 and 88, has a length C. Knowing the angles a, b and the length C, all the angles and side lengths of the triangle 88-80-74 may be determined. Digital image information is transmitted to processor 36, which determines 3D coordinates of the surface 62. The processor 36 may also instruct the illuminated pattern generator 70 to generate an appropriate pattern.

As used herein, the term “pose” refers to a combination of a position and an orientation. In embodiment, the position and the orientation are desired for the camera and the projector in a frame of reference of the optical system 22. Since a position is characterized by three translational degrees of freedom (such as x, y, z) and an orientation is composed of three orientational degrees of freedom (such as roll, pitch, and yaw angles), the term pose defines a total of six degrees of freedom. In a triangulation calculation, a relative pose of the camera and the projector are desired within the frame of reference of the optical system 22. As used herein, the term “relative pose” is used because the perspective center of the camera or the projector can be located on an (arbitrary) origin of the optical system 22; one direction (say the x axis) can be selected along the baseline; and one direction can be selected perpendicular to the baseline and perpendicular to an optical axis. In most cases, a relative pose described by six degrees of freedom is sufficient to perform the triangulation calculation. For example, the origin of a optical system 22 can be placed at the perspective center of the camera. The baseline (between the camera perspective center and the projector perspective center) may be selected to coincide with the x axis of the optical axis. The y axis may be selected perpendicular to the baseline and the optical axis of the camera. Two additional angles of rotation are used to fully define the orientation of the camera system. Three additional angles or rotation are used to fully define the orientation of the projector. In this embodiment, six degrees-of-freedom define the state of the optical system 22: one baseline, two camera angles, and three projector angles. In other embodiment, other coordinate representations are possible.

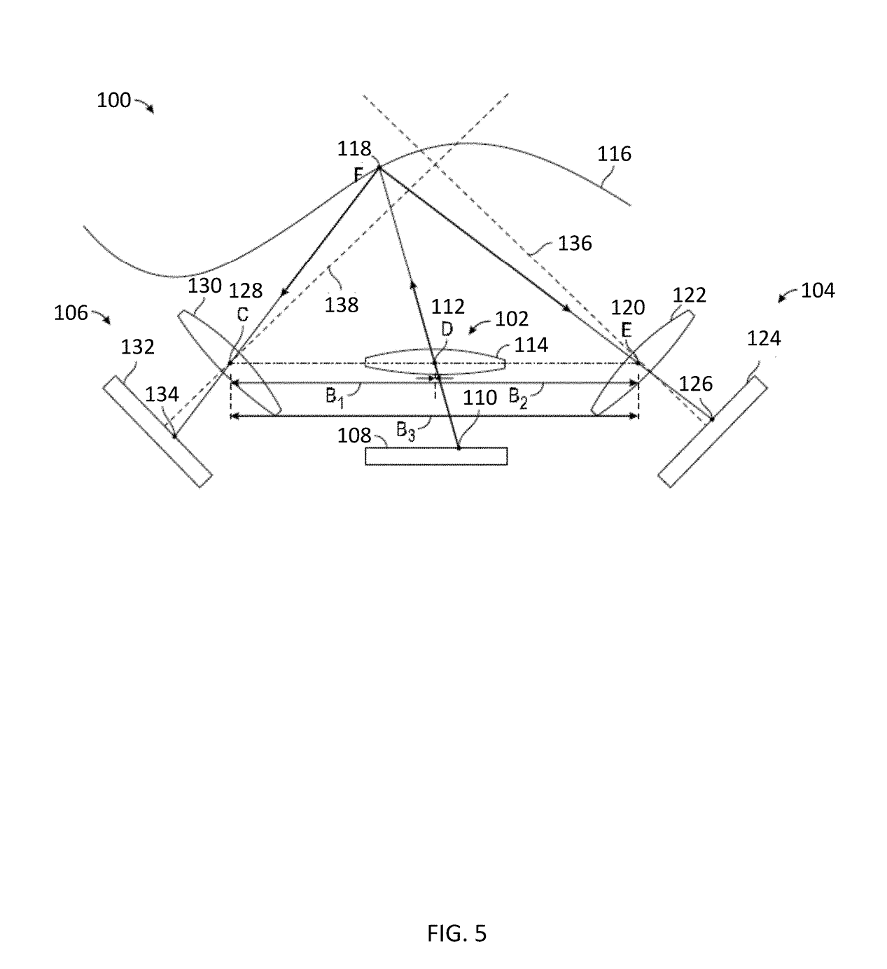

Referring now to FIG. 5, the 3D imager 20 includes an optical system 100 having a projector 102, a first camera 104, and a second camera 106. It should be appreciated that the scanner 100 has the same configuration as optical system 22 illustrated in FIGS. 1-3. The projector 102 creates a pattern of light on a pattern generator plane 108, which it projects from a corrected point 110 on the pattern through a perspective center 112 (point D) of the lens 114 onto an object surface 116 at a point 118 (point F). The point 118 is imaged by the first camera 104 by receiving a ray of light from the point 118 through a perspective center 120 (point E) of a lens 122 onto the surface of a photosensitive array 124 of the camera as a corrected point 126. The point 126 is corrected in the read-out data by applying a correction factor to remove the effects of lens aberrations. The point 118 is likewise imaged by the second camera 106 by receiving a ray of light from the point 118 through a perspective center 128 (point C) of the lens 130 onto the surface of a photosensitive array 132 of the second camera as a corrected point 134.

The inclusion of two cameras 104 and 106 in the system 100 provides advantages over the device of FIG. 4 that includes a single camera. One advantage is that each of the two cameras has a different view of the point 118 (point F). Because of this difference in viewpoints, it is possible in some cases to see features that would otherwise be obscured—for example, seeing into a hole or behind a blockage. In addition, it is possible in the system 100 of FIG. 5 to perform three triangulation calculations rather than a single triangulation calculation, thereby improving measurement accuracy. A first triangulation calculation can be made between corresponding points in the two cameras using the triangle CEF with the baseline B₃. A second triangulation calculation can be made based on corresponding points of the first camera and the projector using the triangle DEF with the baseline B₂. A third triangulation calculation can be made based on corresponding points of the second camera and the projector using the triangle CDF with the baseline B₁. The optical axis of the first camera 104 is 136, and the optical axis of the second camera 106 is 138.

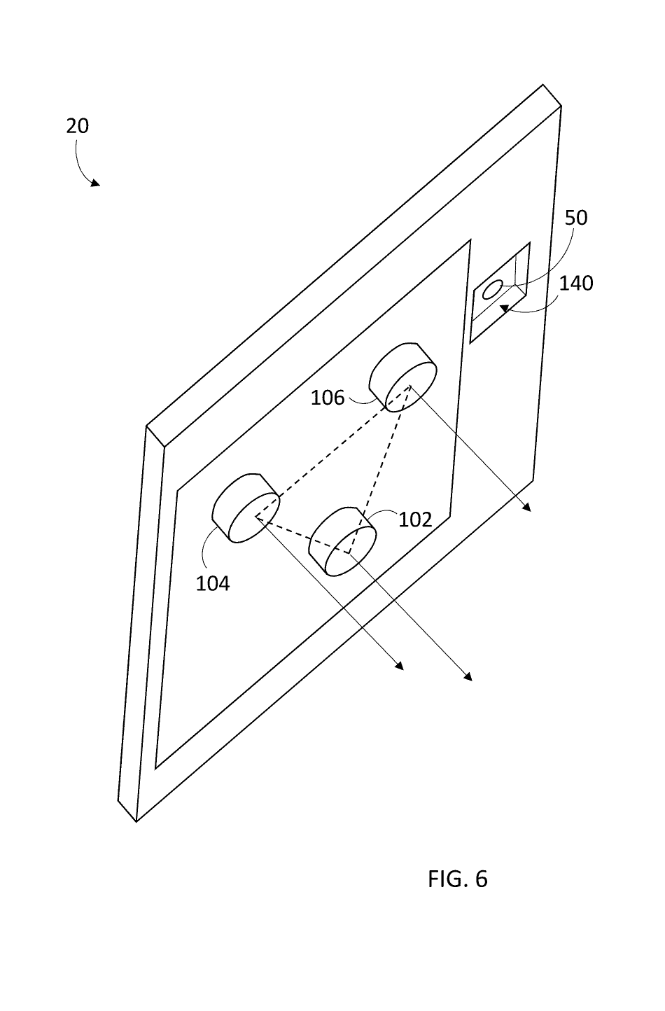

FIG. 6 shows 3D imager 20 having two cameras 104, 106 and a projector 102 arranged in a triangle A₁-A₂-A₃. In an embodiment, the 3D imager 20 of FIG. 6 further utilizes camera 50 of the mobile computing device 34 that may be used to provide color (texture) information for incorporation into the 3D image. In addition, the camera 50 may be used to register multiple 3D images through the use of videogrammetry. In an embodiment, the case 32 includes an opening 140 that is aligned with the camera 50 to allow the acquisition of images by the camera 50 through the case 32. As will be discussed in more detail herein, the camera 50 may also be used in place of one of the cameras 104, 106.

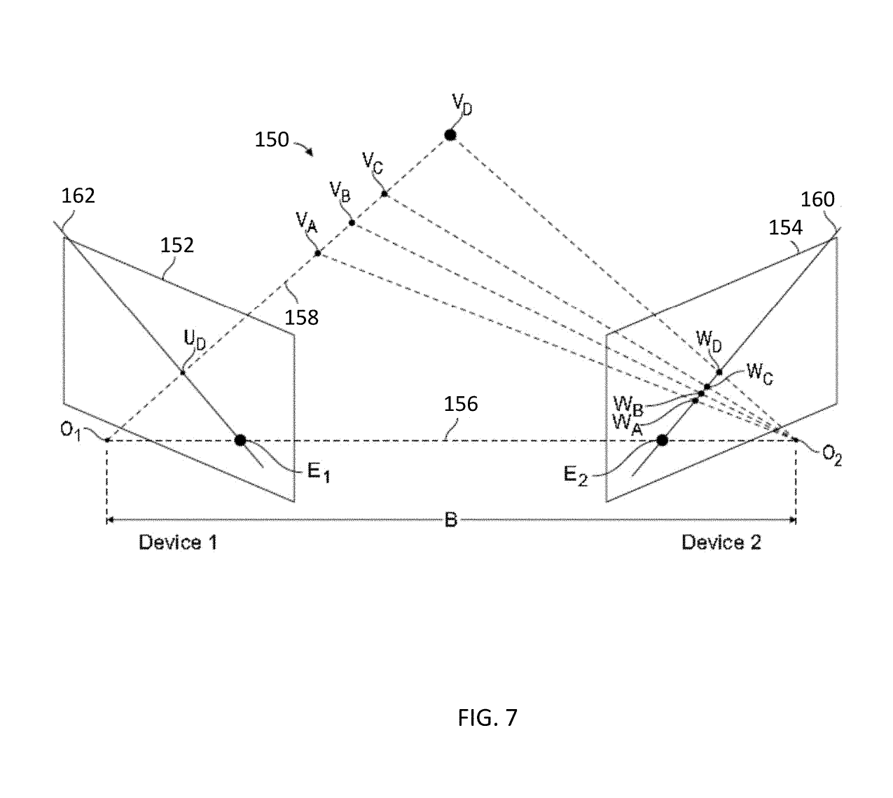

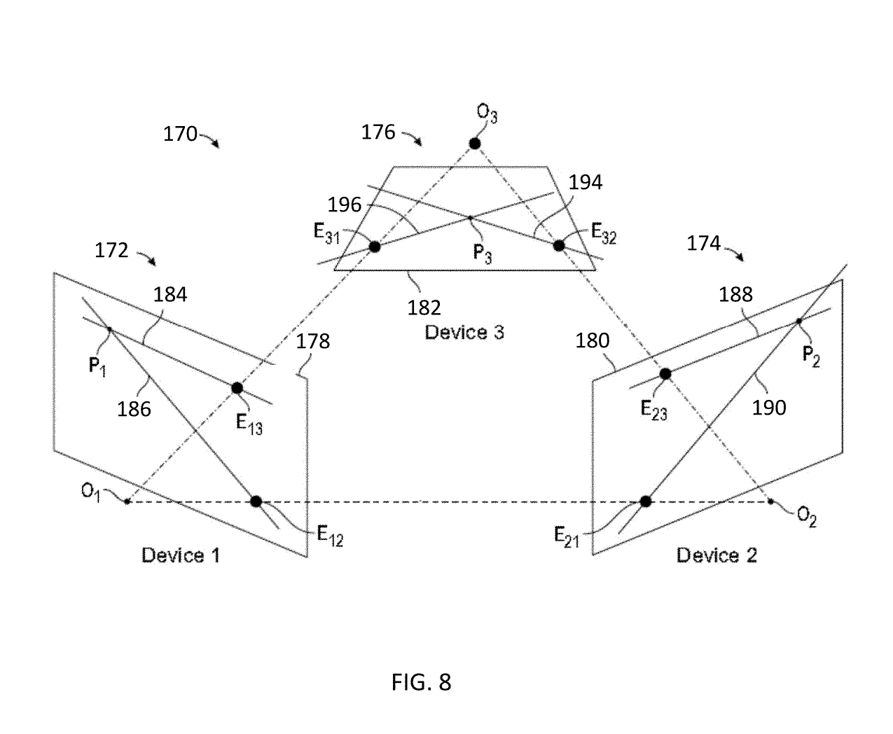

A triangular arrangement of the cameras 104, 106 with the projector 102 provides additional information beyond that available for two cameras and a projector arranged in a straight line. The additional information may be understood in reference to FIG. 7, which describes the concept of epipolar constraints, and FIG. 8 that explains how epipolar constraints are advantageously applied to the triangular arrangement of the 3D imager 100. Referring to FIG. 7, a 3D triangulation instrument 150 includes a device 1 and a device 2 on the left and right sides of FIG. 7, respectively. Device 1 and device 2 may be two cameras or device 1 and device 2 may be one camera and one projector. Each of the two devices, whether a camera or a projector, has a perspective center, O₁ and O₂, and a representative plane, 152 or 154. The perspective centers are separated by a baseline distance B, which is the length of the line 156. The perspective centers O₁, O₂ are points through which rays of light may be considered to travel, either to or from a point on an object. These rays of light either emerge from an illuminated projector pattern, such as the pattern on illuminated projector pattern generator 70 of FIG. 4, or impinge on a photosensitive array, such as the photosensitive array 84 of FIG. 4. As can be seen in FIG. 4, the lens 72 lies between the illuminated object point 80 and plane of the illuminated object projector pattern generator 70. Likewise, the lens 82 lies between the illuminated object point 80 and the plane of the photosensitive array 84, respectively. However, the pattern of the front surface planes of devices 70, 84 would be the same if they were moved to appropriate positions opposite the lenses 72, 82, respectively. This placement of the reference planes 152, 154 is applied in FIG. 7, which shows the reference planes 152, 154 between the object point and the perspective centers O₁, O₂.

In FIG. 7, for the reference plane 152 angled toward the perspective center O₂ and the reference plane 154 angled toward the perspective center O₁, a line 156 drawn between the perspective centers O₁ and O₂ crosses the planes 152, 154 at the epipole points E₁, E₂, respectively. Consider a point U_{D} on the plane 152. If device 1 is a camera, it is known that an object point that produces the point U_{D} on the image lies on the line 158. The object point might be, for example, one of the points V_{A}, V_{B}, V_{C}, or V_{D}. These four object points correspond to the points W_{A}, W_{B}, W_{C}, W_{D}, respectively, on the reference plane 154 of device 2. This is true whether device 2 is a camera or a projector. It is also true that the four points lie on a straight line 160 in the plane 154. This line, which is the line of intersection of the reference plane 154 with the plane of O₁-O₂-U_{D}, is referred to as the epipolar line 160. It follows that any epipolar line on the reference plane 154 passes through the epipole E₂. Just as there is an epipolar line on the reference plane of device 2 for any point on the reference plane of device 1, there is also an epipolar line 162 on the reference plane of device 1 for any point on the reference plane of device 2.

FIG. 8 illustrates the epipolar relationships for a 3D imager 170 corresponding to 3D imager 20 of FIG. 6 in which two cameras and one projector are arranged in a triangular pattern. In general, the device 1, device 2, and device 3 may be any combination of cameras and projectors as long as at least one of the devices is a camera. Each of the three devices 172, 174, 176 has a perspective center O₁, O₂, O₃, respectively, and a reference plane 178, 180, 182, respectively. Each pair of devices has a pair of epipoles. Device 1 and device 2 have epipoles E₁₂, E₂₁ on the planes 178, 180, respectively. Device 1 and device 3 have epipoles E₁₃, E₃₁, respectively on the planes 178, 182, respectively. Device 2 and device 3 have epipoles E₂₃, E₃₂ on the planes 180, 182, respectively. In other words, each reference plane includes two epipoles. The reference plane for device 1 includes epipoles E₁₂ and E₁₃. The reference plane for device 2 includes epipoles E₂₁ and E₂₃. The reference plane for device 3 includes epipoles E₃₁ and E₃₂.

Consider the embodiment of FIG. 8 in which device 3 is a projector, device 1 is a first camera, and device 2 is a second camera. Suppose that a projection point P₃, a first image point P₁, and a second image point P₂ are obtained in a measurement. These results can be checked for consistency in the following way.

To check the consistency of the image point P₁, intersect the plane P₃-E₃₁-E₁₃ with the reference plane 178 to obtain the epipolar line 184. Intersect the plane P₂-E₂₁-E₁₂ to obtain the epipolar line 186. If the image point P₁ has been determined consistently, the observed image point P₁ will lie on the intersection of the determined epipolar lines 184, 186.

To check the consistency of the image point P₂, intersect the plane P₃-E₃₂-E₂₃ with the reference plane 180 to obtain the epipolar line 188. Intersect the plane P₁-E₁₂-E₂₁ to obtain the epipolar line 190. If the image point P₂ has been determined consistently, the observed image point P₂ will lie on the intersection of the determined epipolar lines 188, 190.

To check the consistency of the projection point P₃, intersect the plane P₂-E₂₃-E₃₂ with the reference plane 182 to obtain the epipolar line 194. Intersect the plane P₁-E₁₃-E₃₁ to obtain the epipolar line 196. If the projection point P₃ has been determined consistently, the projection point P₃ will lie on the intersection of the determined epipolar lines 194, 196.

The redundancy of information provided by using a 3D imager 20 having a triangular arrangement of projector and cameras may be used to reduce measurement time, to identify errors, and to automatically update compensation/calibration parameters.

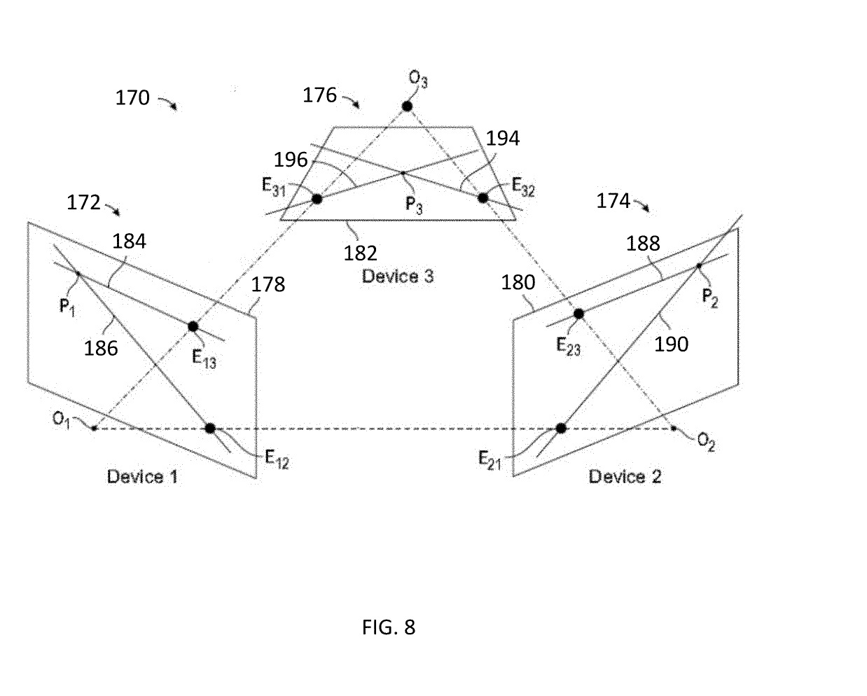

Referring now to FIG. 9 and FIG. 10, with continuing reference to FIGS. 6-8, a method of operating the 3D imager 20 is shown. The method 200 begins in block 202 with the projector 102 projecting a light pattern into an environment 204. In an embodiment, the environment 204 is an interior of a building or another enclosed space that includes a plurality of planar surfaces 206, 208, 210, 212, 214, such as walls, a floor, and a ceiling for example. It should be appreciated that other surfaces, such as doors and cabinets may also form the surfaces. In some embodiments, the surfaces may be curved. With the light pattern projected, the 3D imager 20 acquires with the cameras 104, 106 images of the light pattern on the surfaces 206, 208, 210, 212, 214 in block 216. The cameras 104, 106 acquire a first image and a second image simultaneously or nearly simultaneously.

In an embodiment, images of a “sparse” light pattern are acquired. As used herein, a “sparse” pattern is a pattern of elements that are acquired in a single instant. In an embodiment, the light pattern projected by the projector 102 have a density of about 1000 points per square meter. Thus, the resulting point cloud of the surfaces 206, 208, 210, 212, 214 will have a density of no greater than this light pattern. This is different from prior art imaging systems that acquired multiple images, typically about 10 images per second or higher. As a result, the point cloud generated by the sparse light pattern is about 1000 times less than prior art imagers. It should be appreciated that this reduces the processing power and time to prepare a point cloud.

In an embodiment, the projector 102 projects the pattern of light at a wavelength that is not visible to the human eye, such as in the infrared spectrum about 700 nm. In this embodiment, the camera's 104, 106 are configured to be sensitive to light having a wavelength of the light pattern.

The method 200 then proceeds to block 218 where a two-dimensional color image (i.e. an image lacking depth information) of the environment 204 is acquired using the mobile computing device 34 camera 50. In an embodiment, the camera 50 is a color camera (e.g. having red, green and blue pixels). In an embodiment, the camera 50 has a resolution (number of pixels) that is greater than the cameras 104, 106. In an embodiment, the camera 50 has a resolution of about 8 megapixels. It should be appreciated that acquisition of the color image in block 218 may occur simultaneously with the acquisition of the first image and second image in block 216.

The method 200 then proceeds to block 220 where the 3D coordinates of the elements of the light pattern are determined based at least in part on the first image and the second images acquired by cameras 104, 106. In an embodiment, the 3D coordinates are determined in the manner described with respect to FIG. 8. The 3D coordinates define a point cloud of the environment 204.

The method 200 then proceeds to block 222 where planes defined by surfaces 206, 208, 210, 212, 214 are determined from the point cloud. It should be appreciated that in other embodiments, the surfaces may be fit to other geometric primitives, such as but not limited to cylinders or spheres. In an embodiment, the planes are determined by iteratively selecting three points within the point cloud to define a plane. Normals from remaining points in the point cloud are then compared to the plane. When the surrounding points are either on the plane or their normal is within a predetermined distance of the normal, then the point is defined as being on the plane. Once all of the points in the point cloud are compared, the points on the plane are removed from the data set and another set of three-points are selected to define a plane. In an embodiment, this process is iteratively performed until all of the points (or substantially all of the points) are defined as being on a plane. In one embodiment, the method of defining the planes is based on a random sample consensus (RANSAC) method. In an embodiment, when the planes are identified, they are classified as being vertical (e.g. walls) or horizontal (e.g. floors or ceilings).

The method 200 then proceeds to block 224 where lines are identified in the color image acquired by camera 50. It should be appreciated that lines in a two-dimensional image may, at least in some instances, represent edges that define the boundary of a plane. For example the corner 226 is a line in the 2D image representing the boundary between the surface 206 and the surface 214. Similarly, the intersection of the floor 208 and the surface 206 is a line 228 in the two-dimensional image. These lines may be identified using imaging processing methods, such as Canny edge detection, Marr-Hildreth edge detection, Gaussian filtering, discrete Laplace operator, or Hough transform for example.

The method 200 then proceeds to block 230 where the lines identified in block 224 are matched with the planes identified in block 222. In an embodiment, the matching of the lines with the edges of the planes is performed using the method described in “Brute Force Matching Between Camera Shots and Synthetic Images from Point Clouds” by R. Boerner et al., published in the The International Archive of the Photogrammetry, Remote Sensing and Spatial Information Sciences, Volume, XLI-B5, 2016. In another embodiment, the matching may be performed using the method described in “registration of Images to Unorganized 3D Point Clouds Using Contour Cues” by Alba Pujol-Miro et al, published in the 25^{th} European Processing Conference, 2017.

With the lines matched to the point cloud, the method 200 then proceeds to block 232 where the image of the environment 204 is displayed to the operator, such as on user interface 48 for example. Since the displayed two-dimension image is aligned and associated with the 3D point cloud, the operator may select points on the displayed two-dimensional image and be provided with the distance between the points. In an embodiment, when the operator selects two points, the method 200 returns a distance by determining a correspondence between the selected points on the two-dimensional image and the point cloud. This may include identifying a locations on planes (determined in block 222) and then determining a distance therebetween. It should be appreciated that the method 200 may also return other measurements, such as areas of planes, or the volume of a space for example.

It should be appreciated that the 3D imager 20 and the method 200 provide for the rapid acquisition of three-dimensional information of an environment based on a sparse point cloud and provide a means for the operator to obtain measurement information (distance, area, volume, etc.) for arbitrary or desired locations within the environment.

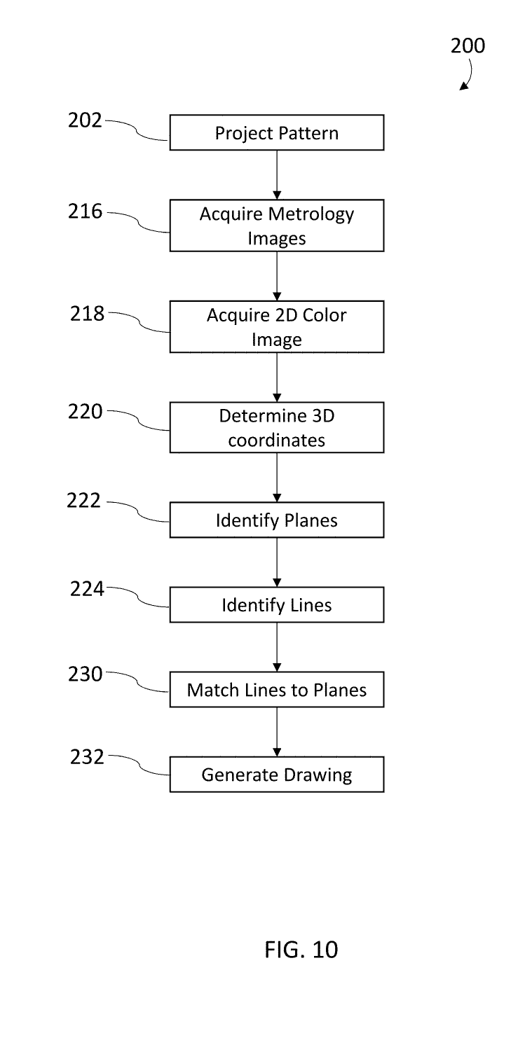

Referring now to FIG. 11, another embodiment is shown of a 3D imager 250. The 3D Imager 250 is similar to the 3D Imager 20 of FIG. 1, except that the projector 252 and the cameras 254, 256 are arranged in an line or linear geometric arrangement, instead of a triangular arrangement. The projector 252 and cameras 254, 256 are coupled to a baseplate 30 as described herein.

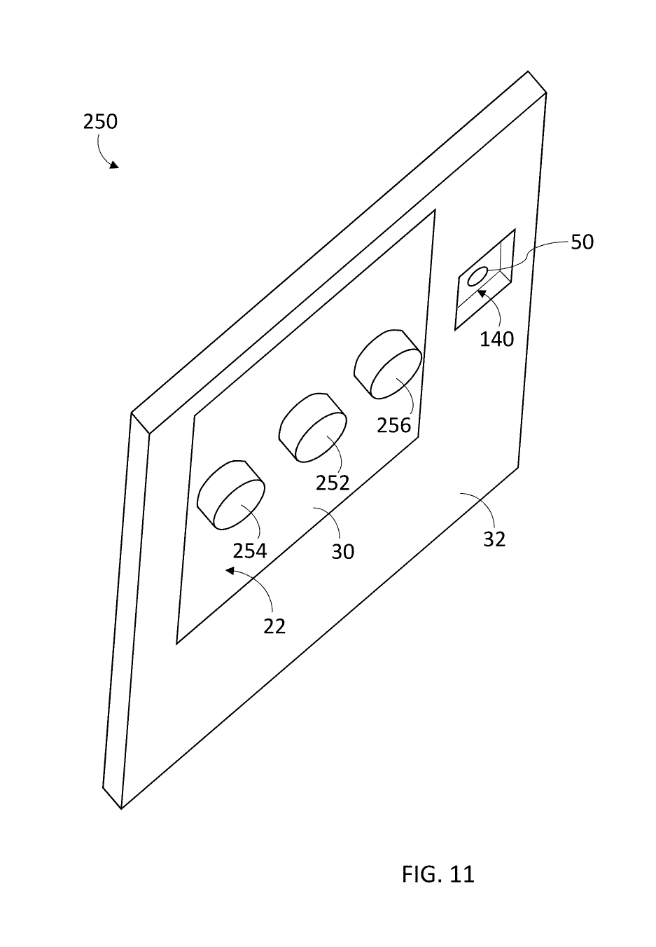

In an embodiment where the 3D imager 250 of FIG. 11 and FIG. 12 is a single-shot scanner that determines 3D coordinates based on a single projection of a projection pattern and a single image captured by each of the two cameras in the same instance. Then a correspondence between the projector point and image points may be obtained by matching a coded pattern projected by the projector 252 and received by the two cameras 254, 256. Alternatively, the coded pattern may be matched for two of the three elements—for example, the two cameras 254, 256 or for the projector 250 and one of the two cameras 254, 256. This is possible in a single-instance or single-shot type triangulation scanner because of coding in the projected elements or in the projected pattern or both.

After a correspondence is determined among projected and imaged elements, a triangulation calculation is performed to determine 3D coordinates of the projected element on an object. In an embodiment, the elements are uncoded spots projected in an uncoded pattern. In an embodiment, a triangulation calculation is performed based on selection of a spot for which correspondence has been obtained on each of two cameras. In this embodiment, the relative position and orientation of the two cameras is used. For example, the baseline distance between the perspective centers is used to perform a triangulation calculation based on the first image of the first camera 254 and on the second image of the second camera 256. Likewise, the first baseline is used to perform a triangulation calculation based on the projected pattern of the projector 252 and on the second image of the second camera 256. Similarly, the second baseline is used to perform a triangulation calculation based on the projected pattern of the projector 252 and on the first image of the first camera 254. In an embodiment of the present invention, the correspondence is determined based at least on an uncoded pattern of uncoded elements projected by the projector, a first image of the uncoded pattern captured by the first camera, and a second image of the uncoded pattern captured by the second camera. In an embodiment, the correspondence is further based at least in part on a position of the projector, the first camera, and the second camera. In a further embodiment, the correspondence is further based at least in part on an orientation of the projector, the first camera, and the second camera.

The term “uncoded element” or “uncoded spot” as used herein refers to a projected or imaged element that includes no internal structure that enables it to be distinguished from other uncoded elements that are projected or imaged. The term “uncoded pattern” as used herein refers to a pattern in which information is not encoded in the relative positions of projected or imaged elements. For example, one method for encoding information into a projected pattern is to project a quasi-random pattern of “dots” in which the relative position of the dots is known ahead of time and can be used to determine correspondence of elements in two images or in a projection and an image. Such a quasi-random pattern contains information that may be used to establish correspondence among points and hence is not an example of a uncoded pattern. An example of an uncoded pattern is a rectilinear pattern of projected pattern elements.

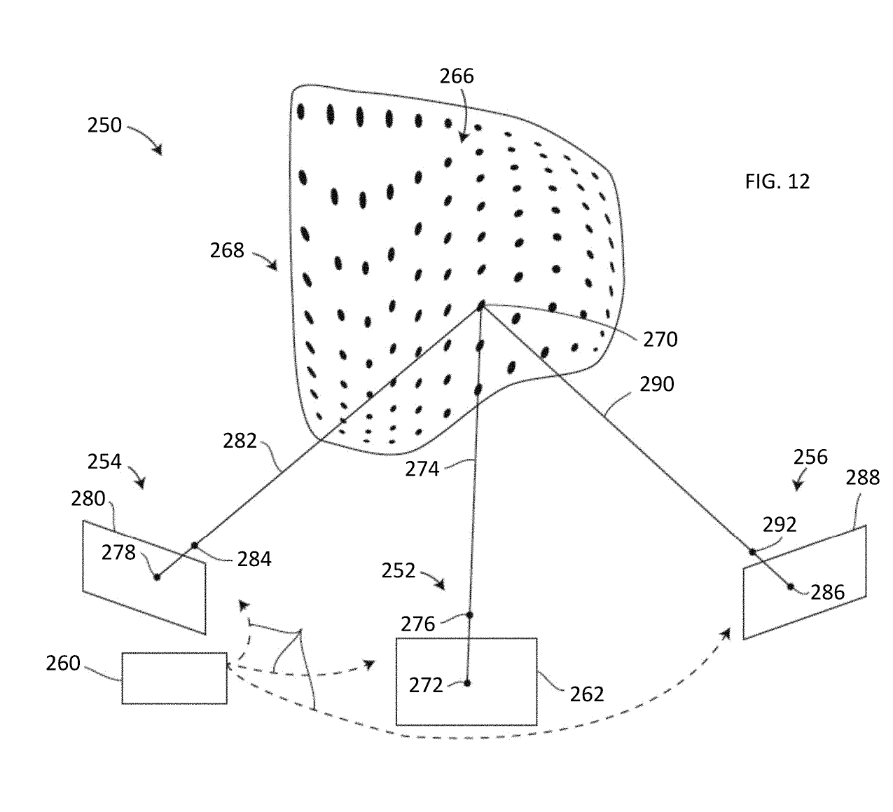

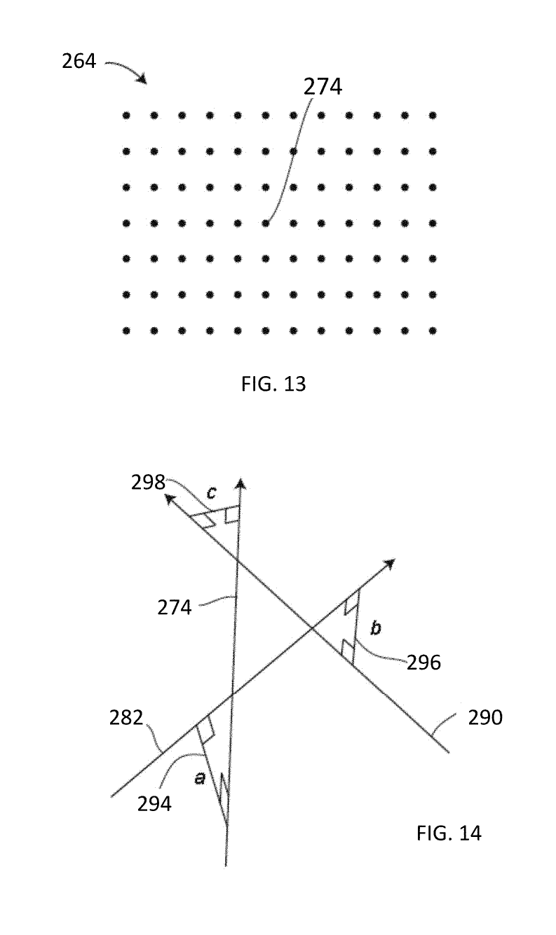

In an embodiment, uncoded spots are projected in an uncoded pattern as illustrated in the 3D imager 250 of FIG. 12. In an embodiment, the 3D imager 250 includes projector 252, a first camera 254, a second camera 254, and a processor 260. It should be appreciated that the processor 260 is disposed within the mobile computing device. The projector 252 projects an uncoded pattern of uncoded spots off a projector reference plane 262. In an embodiment illustrated in FIG. 13 and FIG. 14, the uncoded pattern of uncoded spots is a rectilinear array 264 of circular spots that form illuminated object spots 266 on the object 268. In an embodiment, the rectilinear array of spots 264 arriving at the object 268 is modified or distorted into the pattern of illuminated object spots 266 according to the characteristics of the object 268. An exemplary uncoded spot 266 from within the projected rectilinear array 264 is projected onto the object 268 as a spot 270. The direction from the projector spot 272 to the illuminated object spot 270 may be found by drawing a straight line 274 from the projector spot 272 on the reference plane 252 through the projector perspective center 276. The location of the projector perspective center 276 is determined by the characteristics of the projector optical system.

In an embodiment, the illuminated object spot 270 produces a first image spot 278 on the first image plane 280 of the first camera 254. The direction from the first image spot to the illuminated object spot 270 may be found by drawing a straight line 282 from the first image spot 278 through the first camera perspective center 284. The location of the first camera perspective center 284 is determined by the characteristics of the first camera optical system.

In an embodiment, the illuminated object spot 270 produces a second image spot 286 on the second image plane 288 of the second camera 256. The direction from the second image spot 286 to the illuminated object spot 270 may be found by drawing a straight line 290 from the second image spot 286 through the second camera perspective center 292. The location of the second camera perspective center 292 is determined by the characteristics of the second camera optical system.

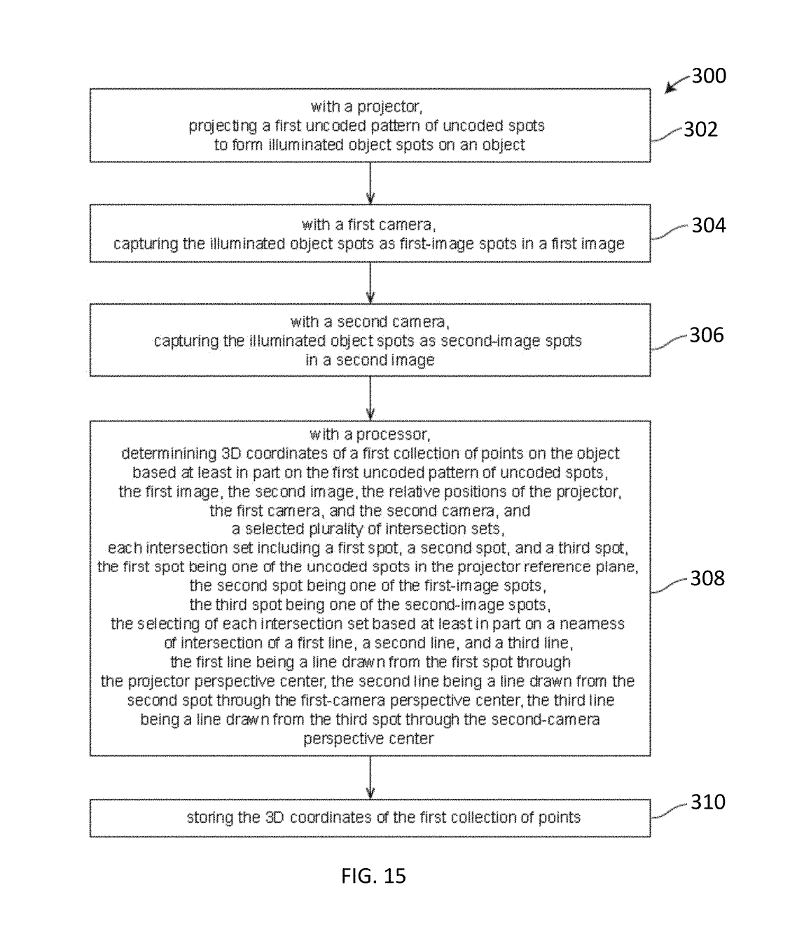

FIG. 15 shows elements of a method 300 for determining 3D coordinates of points on an object. An element 302 includes projecting, with a projector, a first uncoded pattern of uncoded spots to form illuminated object spots on an object. In the embodiment of FIG. 11 and FIG. 12, the projector 252 projects a first uncoded pattern of uncoded spots 264 to form illuminated object spots 266 on a surface of an object 268.

The method 300 then proceeds to block 304 that includes capturing with a first camera the illuminated object spots as first-image spots in a first image. In the embodiment of FIG. 11 and FIG. 12 the first camera 254 captures or acquires illuminated object spots 266, including the first-image spot 278, which is an image of the illuminated object spot 270. The method 300 then proceeds to block 306, which includes capturing with a second camera the illuminated object spots as second-image spots in a second image. In the embodiment of FIG. 11 and FIG. 12, the second camera 256 captures illuminated object spots 264, including the second-image spot 286, which is an image of the illuminated object spot 270.

In an embodiment, the method 300 then proceeds to block 308 to determine the 3D coordinates of at least some of the spots 266. In an embodiment, a first aspect includes determining with a processor 3D coordinates of a first collection of points on the object based at least in part on the first uncoded pattern of uncoded spots, the first image, the second image, the relative positions of the projector, the first camera, and the second camera, and a selected plurality of intersection sets. In the embodiment of FIG. 11 and FIG. 12, the processor 260 determines the 3D coordinates of a first collection of points corresponding to object spots 266 on the object 268 based at least in the first uncoded pattern of uncoded spots 264, the first image 280, the second image 288, the relative positions of the projector 252, the first camera 254, and the second camera 256, and a selected plurality of intersection sets. An example from FIG. 12 of an intersection set is the set that includes the points 272, 278, 286. Any two of these three points may be used to perform a triangulation calculation to obtain 3D coordinates of the illuminated object spot 270 as discussed herein.

In an embodiment, a second aspect of the determining of 3D coordinates in block 308 includes selecting with the processor a plurality of intersection sets, each intersection set including a first spot, a second spot, and a third spot, the first spot being one of the uncoded spots in the projector reference plane, the second spot being one of the first-image spots, the third spot being one of the second-image spots. The selecting of each intersection set based at least in part on the nearness of intersection of a first line, a second line, and a third line, the first line being a line drawn from the first spot through the projector perspective center, the second line being a line drawn from the second spot through the first-camera perspective center, the third line being a line drawn from the third spot through the second-camera perspective center. In the embodiment of FIG. 11 and FIG. 12 one intersection set includes the first spot 272, the second spot 278, and the third spot 286. In this embodiment, the first line is the line 274, the second line is the line 282, and the third line is the line 290. The first line 274 is drawn from the uncoded spot 272 in the projector reference plane 262 through the projector perspective center 276. The second line 282 is drawn from the first-image spot 278 through the first-camera perspective center 284. The third line 290 is drawn from the second-image spot 286 through the second-camera perspective center 292. The processor 260 selects intersection sets based at least in part on the nearness of intersection of the first line 274, the second line 282, and the third line 290.

The processor 260 may determine the nearness of intersection of the first line, the second line, and the third line based on any of a variety of criteria. For example, in an embodiment, the criterion for the nearness of intersection is based on a distance between a first 3D point and a second 3D point. In an embodiment, the first 3D point is found by performing a triangulation calculation using the first image point 278 and the second image point 286, with the baseline distance used in the triangulation calculation being the distance between the perspective centers 284, 292. In the embodiment, the second 3D point is found by performing a triangulation calculation using the first image point 278 and the projector point 272, with the baseline distance used in the triangulation calculation being the distance between the perspective centers 284, 276. If the three lines 274, 282, 290 nearly intersect at the object point 270, then the calculation of the distance between the first 3D point and the second 3D point will result in a relatively small distance. On the other hand, a relatively large distance between the first 3D point and the second 3D would indicate that the points 272, 278, 286 did not all correspond to the object point 270.

As another example, in an embodiment, the criterion for the nearness of the intersection is based on a maximum of closest-approach distances between each of the three pairs of lines. This situation is illustrated in FIG. 14. A line of closest approach 294 is drawn between line 274 and line 282. The line 294 is perpendicular to each of the lines 274, 282 and has a nearness-of-intersection length a. A line of closest approach 296 is drawn between line 282 and line 290. The line 296 is perpendicular to each of the lines 282, 290 and has length b. A line of closest approach 298 is drawn between line 274 and line 290. The line 298 is perpendicular to each of the lines 274, 290 and has length c. According to the criterion described in the embodiment above, the value to be considered is the maximum of a, b, and c. A relatively small maximum value would indicate that points 272, 278, 286 have been correctly selected as corresponding to the illuminated object point 270. A relatively large maximum value would indicate that points 272, 278, 286 were incorrectly selected as corresponding to the illuminated object point 270.

The processor 260 may use many other criteria to establish the nearness of intersection. For example, for the case in which the three lines were coplanar, a circle inscribed in a triangle formed from the intersecting lines would be expected to have a relatively small radius if the three points 272, 278, 286 corresponded to the object point 270. For the case in which the three lines were not coplanar, a sphere having tangent points contacting the three lines would be expected to have a relatively small radius.

It should be noted that the selecting of intersection sets based at least in part on a nearness of intersection of the first line, the second line, and the third line is not used in other projector-camera methods based on triangulation. For example, for the case in which the projected points are coded points, which is to say, recognizable as corresponding when compared on projection and image planes, there is no need to determine a nearness of intersection of the projected and imaged elements. Likewise, when a sequential method is used, such as the sequential projection of phase-shifted sinusoidal patterns, there is no need to determine the nearness of intersection as the correspondence among projected and imaged points is determined based on a pixel-by-pixel comparison of phase determined based on sequential readings of optical power projected by the projector and received by the camera(s). The method element 190 includes storing 3D coordinates of the first collection of points.

Once the 3D coordinates are determined in block 308, the method 300 proceeds to block 310 where the 3D coordinates are stored in memory, such as memory 40 (FIG. 3).

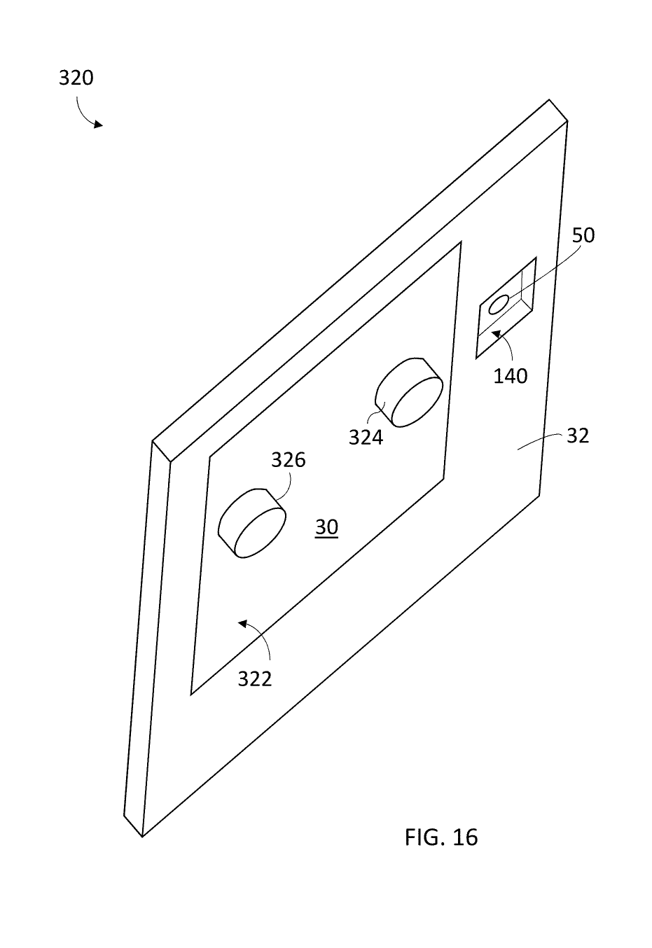

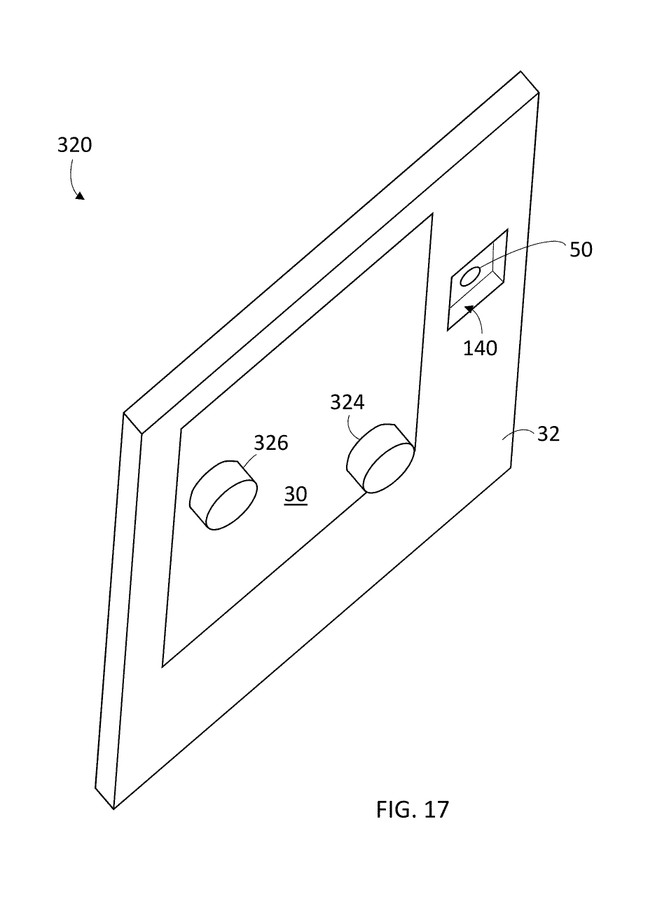

It should be appreciated that the embodiments of FIGS. 1-15 illustrate the 3D imager as having two cameras mounted to the baseplate 30. Referring to FIG. 16 and FIG. 17, another 3D imager 320 is shown. The 3D imager 320 has an optical system 322 has a projector 324 and a single camera 326 mounted on a baseplate 30. In this embodiment, the camera 50 provides the third device for the determination of three-dimensional coordinates. In the embodiment of FIG. 16 the devices 324, 326, 50 are arranged linearly (e.g. aligned along a straight line) similar to the embodiment of FIG. 11. In the embodiment of FIG. 17, the devices 324, 326, 50 are arranged in a triangular geometric arrangement, similar to the embodiment of FIG. 1.

Technical effects and benefits of some embodiments include providing a method and a system that allow for measurements of an environment to be quickly performed by measuring the three-dimensional coordinates of points on surfaces within the environment by acquiring images at a single instance in time.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A system for noncontact measurement of an environment, the system comprising:
a measurement system having a baseplate and a light projector, the light projector being mounted to the baseplate;
a tablet computer coupled to the measurement system and having a processor, memory, a user interface and a tablet camera, the processor being operably coupled to the light projector, the processor being responsive to nontransitory executable computer instructions, when executed on the processor for performing a method comprising:
causing the light projector to emit a light pattern onto a plurality of surfaces in the environment and causing the tablet camera to acquire an image of the light pattern at a first instance on the plurality of surfaces;
causing the tablet camera to acquire a color image of the plurality of surfaces;
determining three-dimensional coordinates of points on the plurality of surfaces based at least in part on the image of the light pattern acquired at the first instance, and determining at least one plane in the environment from the three-dimensional coordinates;
determining a plurality of contrast lines in the color image;
matching at least two lines of the plurality of lines to the at least one plane; and
aligning the color image and the three-dimensional coordinate of points into a common coordinate frame of reference.

2. The system of claim 1, wherein:
measurement system include at least one camera coupled to the baseplate in a predetermined geometric relationship with the light projector; and
the method further comprises:
causing the at least one camera to acquire a second image of the light pattern at a first instance on the plurality of surfaces;
determining the three-dimensional coordinates of points on the plurality of surfaces based at least in part on the second image of the light pattern acquired at the first instance and the predetermined geometrical relationship, and determining at least one plane in the environment from the three-dimensional coordinates;

3. The system of claim 2, wherein the baseplate is made from a carbon-fiber material.

4. The system of claim 2, wherein the at least one camera includes a first camera and a second camera.

5. The system of claim 4, wherein the light projector, the first camera and the second camera are arranged in a triangular geometric relationship.

6. The system of claim 4, wherein the light projector is disposed between the first camera and the second camera in a linear geometric relationship.

7. The system of claim 2, wherein the tablet computer further includes a port, the light projector and the at least one camera being coupled to the processor via the port.

8. The system of claim 1, further comprising a case, wherein the case includes a first recess sized to receive the tablet computer and a second recess sized to receive the baseplate, the second recess being on an opposite side of the case from the first recess.

9. The system of claim 8, wherein the case further includes an opening extending from the first recess through the case, the opening being aligned with the tablet camera.

10. A method for noncontact measurement of an environment, the method comprising:
projecting a light pattern with a light projector onto a plurality of surfaces in the environment;
acquiring at a first instance, with at least one camera, an image of the light pattern on the plurality of surfaces, the light projector and the at least one camera being coupled to a baseplate in a predetermined geometrical relationship;
acquiring a color image of the plurality of surfaces with a camera of a table computer;
determining three-dimensional coordinates of points on the plurality of surfaces based at least in part on the image of the light pattern acquired at the first instance and the predetermined geometrical relationship;
determining at least one plane in the environment from the three-dimensional coordinates;
determining a plurality of lines in the color image;
matching at least two lines of the plurality of lines to the at least one plane; and
aligning the color image and the three-dimensional coordinate of points into a common coordinate frame of reference.

11. The method of claim 10, wherein the baseplate is made from a carbon-fiber material.

12. The method of claim 10, wherein the at least one camera includes a first camera and a second camera.

13. The method of claim 12, wherein the light projector, the first camera and the second camera are arranged in a triangular geometric relationship.

14. The method of claim 12, wherein the light projector is disposed between the first camera and the second camera in a linear geometric relationship.

15. The method of claim 10, further comprising transmitting a signal from the at least one camera to the tablet computer further includes a port, the light projector and the at least one camera being coupled to the processor via the port.

16. The system of claim 10, wherein the case includes a first recess sized to receive the tablet computer and a second recess sized to receive the baseplate, the second recess being on an opposite side of the case from the first recess.

17. The system of claim 16, wherein the case further includes an opening extending from the first recess through the case, the opening being aligned with the tablet camera.

18. A system for noncontact measurement of an environment, the system comprising:
a case having a first side and a second side;
a measurement system coupled to the first side, the measurement system having a baseplate, a light projector and at least one camera, the light projector and a first camera being mounted to the baseplate in a predetermined geometric relationship, the at least one camera having a first resolution;
a tablet computer coupled to the second side, the tablet computer having a processor, memory, a user interface and a second camera, the user interface being visible to an operator from the second side, the camera having a second resolution, the second resolution being higher than the first resolution, the processor being operably coupled to the light projector and the at least one camera, the processor being responsive to nontransitory executable computer instructions, when executed on the processor for performing a method comprising:
causing the light projector to emit a light pattern onto a plurality of surfaces in the environment;
causing the first camera to acquire a first image of the light pattern on the plurality of surfaces;
causing the second camera to acquire a second image of the light pattern;
causing the second camera to acquire a color image of the plurality of surfaces;
determining three-dimensional coordinates of points on the plurality of surfaces based at least in part on the first image and the second image of the light pattern and the predetermined geometrical relationship, and determining at least one plane in the environment from the three-dimensional coordinates;
determining a plurality of lines in the color image;
matching at least two lines of the plurality of lines to the at least one plane; and
aligning the color image and the three-dimensional coordinates of points into a common coordinate frame of reference.

19. The system of claim 18, wherein the baseplate is made from a carbon-fiber material.

20. The system of claim 18, wherein the at least one camera includes a first camera and a second camera.

21. The system of claim 20, wherein the light projector, the first camera and the second camera are arranged in a triangular geometric relationship or a linear geometric relationship.
